(19) United States
(12) Patent Application Publication
(10) Pub. No.: US 2024/0364205 A1
(43) Pub. Date: Oct. 31, 2024

(54) POWER CONVERSION CIRCUIT, POWER CONVERSION DEVICE AND POWER SUPPLY MODULE

(71) Applicant: SHANGHAI METAPWR ELECTRONICS CO., LTD, Shanghai (CN)

(72) Inventor: Haoyi Ye, Shanghai (CN)

(73) Assignee: SHANGHAI METAPWR ELECTRONICS CO., LTD, Shanghai (CN)

(21) Appl. No.: 18/646,681

(22) Filed: Apr. 25, 2024

(30) Foreign Application Priority Data
Apr. 26, 2023 (CN) 202310460756.3

(51) Int. Cl. H02M 1/00; H02M 3/156

(52) U.S. Cl. CPC H02M 1/0048; H02M 3/156

(57) ABSTRACT

A power conversion circuit and a power conversion device are provided. In the power conversion circuit, the upper switch, the middle switch and the lower switch form a three-switch bridge arm; By controlling the duty ratio of the upper switch, the gain ratio of the required input voltage to the output voltage is realized; On the other hand, the layout of the power conversion device is disclosed, and the layout of the power conversion device comprises the layout of a transformer area, a switch area, an inductance area and components. A driving power supply scheme which is used for realizing driving power supply of the three-switch bridge arm. A pre-charging unit which is used for pre-charging the flying capacitor before the power conversion device is started, and the instantaneous impact current generated when the switch in the power conversion circuit is turned on is reduced.

### CROSS-REFERENCE TO RELATED APPLICATIONS

This application claims the priority benefit of Chinese patent application 202310460756.3 filed on Apr. 26, 2023. The entirety of the above-mentioned patent application is hereby incorporated by reference herein and made a part of this specification.

### BACKGROUND

With the development of artificial intelligence, the power requirements of intelligent data processing chips, such as GPU CPU NPU and the like (collectively referred to as XPU) become higher and higher, so that the power of the server is increased, the input voltage of the server gradually changes from 12V to 48V, and the working voltage of the XPU becomes lower and lower along with the progress of the process, and gradually moves from 0.8 V to 0.65 V. Therefore, the gain ratio of the input voltage to the output voltage becomes larger and larger, so that the two-stage buck circuit architecture becomes mainstream gradually; and in order to obtain a high 48V input to 0.65 V output conversion efficiency, the intermediate bus voltage moves from 12 V to 6.75 V or even 3.3V.

The application provides a 48V input and 3.3 V voltage stabilization output power supply module solution with high power density and high conversion efficiency.

### SUMMARY

The application aims to provide a power conversion circuit, a power conversion device and a power supply module, which can not only meet the requirements of high gain ratio between an input voltage and an output voltage, but also reduce the loss and reduce the volume through the winding method and the structural layout of the winding. In another aspect, a driving power supply unit and a pre-charging unit suitable for the power conversion circuit are further provided, to further optimize various performance of the power conversion apparatus.

A power conversion circuit, comprising an input end, an output end, an upper switch, a middle switch, at least two lower switches, a flying capacitor and a winding;

Wherein the input end comprises an input positive terminal and an input negative terminal, the output end comprises an output positive terminal and an output negative terminal, and the input negative terminal is electrically connected with the output negative terminal;

wherein the upper switch, the middle switch and the lower switch form a three-switch bridge arm;

wherein one end of the upper switch is electrically connected to the input positive terminal, the other end of the upper switch and one end of the middle switch are electrically connected to the upper node of the three-switch bridge arm, the other end of the middle switch and one end of a lower switch of the three-switch bridge arm are electrically connected to the lower node of the three-switch bridge arm, and the other end of the lower switch of the three-switch bridge arm is electrically connected to the input negative terminal;

wherein the first end of the winding is electrically connected with one end of the flying capacitor, the other end of the flying capacitor is electrically connected to the upper node of the three-switch bridge arm, the second end of the winding is electrically connected to one end of the other lower switch, and the other end of the other lower switch is electrically connected to the input negative terminal.

Preferably, wherein the winding is a high-voltage winding, the power conversion circuit further comprises two low-voltage windings, the second ends of the two low-voltage windings are electrically connected, the first end of one low-voltage winding is electrically connected with the lower node of the three-switch bridge arm, and the first end of the other low-voltage winding is electrically connected with the second end of the high-voltage winding.

Preferably, wherein the second ends of the two low-voltage windings are respectively electrically connected to the output positive terminal.

Preferably, wherein the power conversation circuit further comprises an inductor, wherein a second end of the two low-voltage windings is electrically connected to a second end of the inductor, and a first end of the inductor is electrically connected to the output positive terminal.

Preferably, wherein the high-voltage winding comprises a first high-voltage winding and a second high-voltage winding, a first end of the first high-voltage winding is electrically connected to one end of the flying capacitor, a second end of the first high-voltage winding is electrically connected to a first end of the second high-voltage winding, and a second end of the second high-voltage winding is electrically connected to a first end of the other low-voltage winding.

Preferably, wherein the power conversation circuit further comprises a control signal group, the control signal group comprising a first control signal, a second control signal, a third control signal and a fourth control signal, wherein the first control signal and the second control signal are 180 degrees out of phase, the third control signal is complementary to the first control signal, the fourth control signal is complementary to the second control signal, the first control signal is used for controlling the turn-on and off of the upper switch, the second control signal is used for controlling the turn-on and off of the middle switch, the fourth control signal is used for controlling the turn-on and off of the lower switch in the three-switch bridge arm, and the third control signal is used for controlling the turn-on and off of the other lower switch.

A power conversion device, comprising a winding substrate, at least one switch, a transformer and an inductor, wherein the winding substrate comprises a first surface and a second surface which are opposite to each other;
wherein the first surface comprises a transformer area, a switch area and an inductor area, and/or the at least one second surface comprises a transformer area, a switch area and an inductor area;
wherein the switch area is arranged between the transformer area and the inductor area;

Wherein at least one switch is arranged in the switch area, the transformer is arranged in the transformer area, and the inductor is arranged in the inductor area.

Preferably, wherein the first surface comprises an output area, and/or the second surface comprises an output area;
wherein the power conversion device further comprises at least one output capacitor, the at least one output capacitor is arranged in the output area, and the inductor area is arranged between the switch area and the output area.

Preferably, wherein the second surface further comprises a flying capacitor region, the power conversion device further comprises at least one flying capacitor, the at least one flying capacitor is arranged in the flying capacitor region, and the flying capacitor region is arranged adjacent to the transformer region and the switch region.

Preferably, wherein the switch comprises four lower switches, each of the first surface and the second surface comprises a switch area, the two lower switches are arranged in the switch area on the first surface, and the other two lower switches are arranged in the switch area on the second surface; and the projection of any lower switch arranged in the switch area of the first surface on the first surface overlaps with the projection of one lower switch arranged in the switch area of the second surface on the first surface.

A power supply module, comprising a winding substrate, a heat dissipation substrate and at least one component;
wherein the winding substrate comprises a first surface;
wherein at least one component is arranged on the first surface, and at least one component comprises a non-welding-spot top-surface;
wherein the first surface of the winding substrate comprises at least one non-welding-spot area;
wherein the heat dissipation substrate comprises a bottom surface and a top surface, one part of the bottom surface is fixed to the non-welding-spot area by using heat conduction glue, and the other part of the bottom surface is fixed to the non-welding-spot top-surface by using heat conduction glue.

Preferably, wherein a top surface of the heat dissipation substrate is a plane, and a top surface of the heat dissipation substrate is used for connecting and fixing a heat dissipation device.

Preferably, wherein the winding substrate further comprises a second surface, and the second surface is opposite to the first surface; the power supply module further comprises at least one pin, the at least one pin is arranged on the second surface, and the power module is fixed and electrically connected with one external circuit substrate through the pin.

A power conversion device, comprising an inductor and a winding substrate;
wherein the winding substrate comprises at least one through hole, an internal wiring layer, a first surface and a second surface;
wherein the inductor comprises an inductor magnetic core and an inductor winding, the inductor magnetic core comprises two inductor magnetic substrates, a first winding column and a second winding column, the first winding column and the second winding column are arranged between the two inductor magnetic substrates, and a channel between the first winding column and the second winding column is defined as an inductor winding channel;
wherein the inductor magnetic core further comprises a first inductor winding channel
side and a second inductor winding channel side, and the inductor winding channels penetrate through the first inductor winding channel side and the second inductor winding channel side;
wherein the inductor winding comprises an inductor internal winding and an inductor surface layer winding, the inductor internal winding is arranged on the internal wiring layer, and the inductor surface layer winding is arranged on the first surface;
wherein the inductor internal winding further comprises at least one internal through hole region, an internal first end, an internal second end, a first branch and a second branch, wherein the internal first end is an inductor input end, and the at least one internal through hole region is arranged at the internal second end;
wherein the inductor internal winding penetrates through the inductor winding channel, the first branch is wound around the first winding column, the second branch is woundaround the second winding column, and the at least one internal through hole area and the inductor input terminal are arranged on the same side of the inductor magnetic core;
wherein the inductor surface layer winding comprises at least one surface layer through hole area, a surface layer first end and a surface layer second end, the at least one surface layer through hole area is arranged at the first end of the surface layer, the second end of the surface layer is an inductor output terminal, the inductor surface layer winding penetrates through the inductor winding channel, and the surface layer through hole area and the inductor output terminal are arranged on the two opposite sides of the inductor magnetic core;
wherein the surface through hole area is electrically connected with the internal through hole area through at least one through hole.

Preferably, wherein the power conversation device further comprising at least one component, wherein the at least one component is arranged on the first surface, and a projection of the at least one component on the inductor internal winding overlaps with at least a part of the first branch or the second branch.

Preferably, wherein the inductor input terminal, the internal through hole region and the surface layer through hole region are arranged adjacent to the first inductor winding channel side, and the inductor output terminal is arranged adjacent to the second inductor winding channel side.

A power conversion device, comprising an input end, an output end, a flying capacitor, an output capacitor and a pre-charging circuit unit;
wherein the input end comprises an input positive terminal and an input negative terminal, the output end comprises an output positive terminal and an output negative terminal, and the input negative terminal and the output negative terminal are short-circuited;
wherein the flying capacitor is bridged between the input positive terminal and the output positive terminal;
wherein the output capacitor is bridged between the output positive terminal and the output negative terminal;
wherein one end of the pre-charging circuit unit is electrically connected with the input end of the power conversion device, and the other end of the pre-charging circuit unit is electrically connected with one end of the flying capacitor;
wherein the voltage between the input positive terminal and the input negative terminal is Vin, and the voltage at the two ends of the output capacitor is V1;
wherein before the power conversion device is started, Vin and V1 are configured to meet 0≤V1<Vin 4, and the pre-charging circuit unit charges the flying capacitor to a preset value, the preset value being greater than (Vin/2−V1).

Preferably, wherein when the voltage across the flying capacitor reaches a preset value by the pre-charging circuit unit, the pre-charging circuit unit stops working and the power conversion device starts to work.

Preferably, wherein the maximum value of the preset value is Vin/2.

Preferably, wherein the pre-charging circuit unit comprises a charging triode and a first charging diode, one end of the charging triode is electrically connected with the input positive terminal, the other end of the charging triode is electrically connected with the positive electrode of the first charging diode, and the negative electrode of the first charging diode is electrically connected with the positive voltage end of the flying capacitor.

Preferably, wherein the pre-charging circuit unit further comprises a first pre-charging resistor and a second pre-charging resistor, the resistance values of the first pre-charging resistor and the second pre-charging resistor are equal, the first end of the first pre-charging resistor is electrically connected to the input positive terminal, and the second end of the first pre-charging resistor and the first end of the second pre-charging resistor are electrically connected to the base of the charging triode.

Preferably, wherein a second end of the second pre-charging resistor is electrically connected to an input negative terminal.

Preferably, wherein the power conversation device further comprises a second charging diode, a second end of the second pre-charging resistor being electrically connected to a positive electrode of the second charging electrode, and a positive electrode of the second charging electrode being electrically connected to a negative voltage end of the flying capacitor.

Preferably, wherein the power conversation device further comprises an enabling triode, wherein a collector electrode of the enabling triode is electrically connected to a base electrode of the charging triode, and an emitter electrode of the enabling triode is electrically connected to an input negative terminal.

A power conversion device, comprising a three-switch bridge arm, a first voltage and a second voltage; the three-switch bridge arm comprises an upper switch, a middle switch and a lower switch; and the upper switch, the middle switch and the lower switch are sequentially and electrically connected in series;
wherein the first voltage is less than a second voltage;
wherein the first voltage is used for driving power supply of the lower switch, and the second voltage is used for driving power supply of the middle switch and the upper switch.

Preferably, wherein the power conversation device further comprises a first bootstrap diode and a second bootstrap diode, wherein a positive electrode of the first bootstrap diode is electrically connected to a first voltage, and a negative electrode of the first bootstrap diode is electrically connected to a driving circuit of the middle switch; and a positive electrode of the second bootstrap diode is electrically connected to a negative electrode of the second bootstrap diode, and a negative electrode thereof is electrically connected to a driving circuit of the upper switch.

A power conversion device, comprising a power conversion circuit, a starting power supply unit, an output power supply unit, a working power supply unit and a microprocessor, wherein the power conversion circuit comprises an input end and an output end, and the starting power supply unit is electrically connected with the input end;
wherein when the power conversion circuit is in a standby state or a starting state, the starting power supply unit supplies power to the output power supply unit, and the output power supply unit supplies power to the microprocessor;
wherein when the starting state of the power conversion circuit is finished, the starting power supply unit stops working, the working power supply unit supplies power to the output power supply unit, and the output power supply unit supplies power to the microprocessor.

Preferably, wherein the microprocessor is used for outputting a control signal, and when the starting of the power conversion circuit is finished, the control signal controls the starting power supply unit to stop working.

Preferably, wherein the working power supply unit comprises a coupling winding, a power supply diode and at least one power supply capacitor; the power conversion circuit comprises a power conversion winding, the coupling winding is coupled with the power conversion winding, and coupling voltages at two ends of the coupling winding are rectified and filtered by the power supply diode and the power supply capacitor to supply power to the output power supply unit.

A power conversion device, comprising a winding substrate and a transformer;
wherein the winding substrate comprises at least one internal wiring layer, a first surface and a second surface;
wherein the transformer comprises a high-voltage winding and two low-voltage windings, wherein the high-voltage winding and the two low-voltage windings are arranged on the internal wiring layer;
wherein the number of layers of the internal wiring layer occupied by each of the low-voltage windings is greater than the number of layers of the internal wiring layer occupied by the high-voltage winding.

Preferably, wherein the number of layers of the wiring layer occupied by each of the low-voltage windings is twice the number of layers of the wiring layer occupied by the high-voltage winding.

Preferably, wherein the second ends of the two low-voltage windings are electrically connected to form a center tap connection point.

Preferably, wherein the transformer further comprises a transformer magnetic core, and the transformer magnetic core comprises a first transformer magnetic substrate, a second transformer magnetic substrate, a first side column, a second side column and a middle column; the first side column, the first transformer magnetic substrate, the middle column, the second transformer magnetic substrate and the second side column are sequentially arranged in the same direction; a channel between the first side column and the middle column is a first transformer winding channel, and a channel between the second side column and the middle column is a second transformer winding channel; the transformer magnetic core further comprises a first transformer winding channel side and a second transformer winding channel side opposite to each other; and the first transformer winding channel and the second transformer winding channel penetrate through the first transformer winding channel side and the second transformer winding channel side.

Preferably, wherein after the high-voltage winding sequentially passes through the first transformer winding channel and the second transformer winding channel, the high-voltage winding is wound around at least two circles around the middle column; and the first end and the second end of the high-voltage winding are located on the same winding channel side of the transformer.

Preferably, wherein the high-voltage winding comprises a first high-voltage winding and a second high-voltage winding, the first high-voltage winding surrounds the first side column winding in the first direction from the first end of the first high-voltage winding to the second end of the first high-voltage winding, the first high-voltage winding penetrates through the first transformer winding channel from the second transformer winding channel side to the first transformer winding channel side, and the second end of the first high-voltage winding is electrically connected with the first end of the second high-voltage winding;
wherein the second high-voltage winding is wound from the first end of the second high-voltage winding to the second end of the second high-voltage winding, the second high-voltage winding is wound around the second side column in the second direction, and the second high-voltage winding passes through the second transformer winding channel from the second transformer winding channel side to the first transformer winding channel side.

Preferably, wherein the first end and the second end of each low-voltage winding are arranged on the first transformer winding channel side or the second transformer winding channel side; each low-voltage winding is wound around the first side column or the second side column in the same direction from the first end of the corresponding low-voltage winding to the second end of the corresponding low-voltage winding, and the second ends of the two low-voltage windings are electrically connected.

Preferably, wherein the first end and the second end of each low-voltage winding are arranged on the first transformer winding channel side or the second transformer winding channel side; and each low-voltage winding is wound around the middle column in different directions from the first end of the corresponding low-voltage winding to the second end of the corresponding low-voltage winding, and the second ends of the two low-voltage windings are electrically connected.

Preferably, wherein the first end and the second end of each low-voltage winding are respectively arranged on the first transformer winding channel side and the second transformer winding channel side; each low-voltage winding passes through the first transformer winding channel side and the second transformer winding channel side from the first end of the corresponding low-voltage winding to the second end of the corresponding low-voltage winding, and the second ends of the two low-voltage windings are electrically connected.

### DESCRIPTION OF DRAWINGS

FIG. 1A is a schematic diagram of a topology of a power conversion circuit according to Embodiment 1;

FIG. 1B is a schematic diagram of PWM waveforms of the six power switches shown in FIG. 1A;

FIG. 2 is a schematic diagram of a topology of a power conversion circuit according to Embodiment 2;

FIG. 3A to FIG. 3E are schematic layout diagrams of a power conversion device;

FIG. 4A to FIG. 4B are schematic layout diagrams of the power conversion device and a winding schematic diagram of the transformer assembly;

FIG. 5A to FIG. 5B are schematic diagrams of a partial layout of the power conversion device and a schematic diagram of winding of the inductor assembly;

FIG. 6A is a schematic diagram of a topology of a power conversion circuit according to Embodiment 3;

FIG. 6B is a schematic diagram of winding of a transformer assembly according to Embodiment 3;

FIG. 7A is a schematic diagram of a topology of a power conversion circuit according to Embodiment 4;

FIG. 7B is a schematic diagram of winding of a transformer assembly according to Embodiment 4;

FIG. 8 to FIG. 9 are schematic diagrams of implementation of a driving circuit power supply unit;

FIG. 10A to FIG. 10B are schematic diagrams of implementation of a pre-charging unit.

### DETAILED DESCRIPTION

The present application discloses various embodiments or examples of implementing the thematic technological schemes mentioned. To simplify the disclosure, specific instances of each element and arrangement are described below. However, these are merely examples and do not limit the scope of protection of this application. For instance, a first feature recorded subsequently in the specification formed above or on top of a second feature may include an embodiment where the first and second features are formed through direct contact, or it may include an embodiment where additional features are formed between the first and second features, allowing the first and second features not to be directly connected. Additionally, these disclosures may repeat reference numerals and/or letters in different examples. This repetition is for brevity and clarity and does not imply a relationship between the discussed embodiments and/or structures. Furthermore, when a first element is described as being connected or combined with a second element, this includes embodiments where the first and second elements are directly connected or combined with each other, as well as embodiments where one or more intervening elements are introduced to indirectly connect or combine the first and second elements.

### Embodiment 1

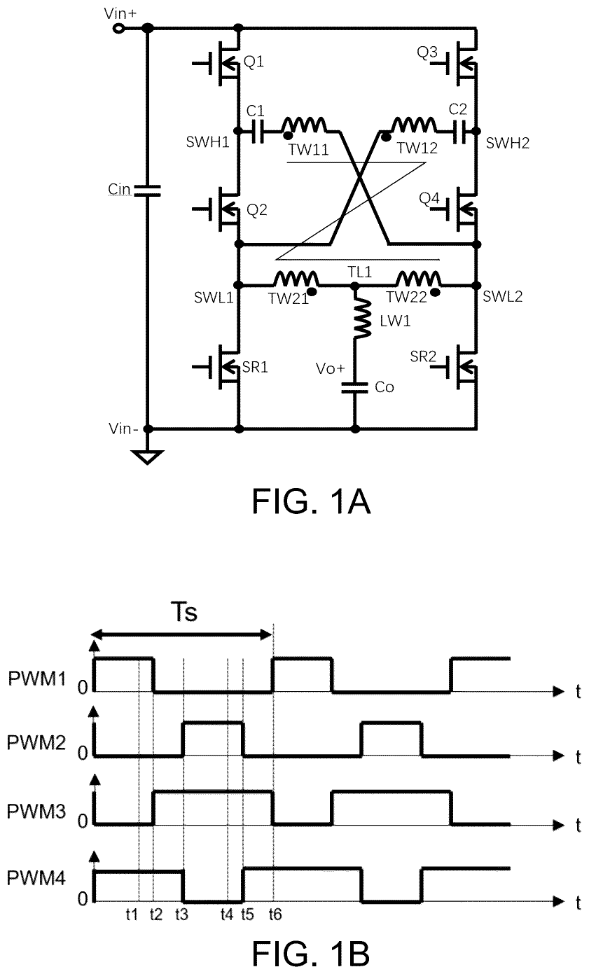

The power conversion circuit topology is shown in FIG. 1A and comprises an input end Vin, an output end Vo, at least one input capacitor Cin, at least one output capacitor Co, two three-switch bridge arms, a transformer, an inductor, a flying capacitor C1 and a flying capacitor C2. The input end Vin comprises an input positive terminal Vin+ and an input negative terminal Vin−, the output end Vo comprises an output positive terminal Vo+ and an output negative terminal Vo−, and the input negative terminal Vin− is short-circuited with the output negative terminal Vo−. The two three-switch bridge arms are electrically connected in parallel and connected in parallel with the input capacitor Cin between the input positive terminal Vin+ and the input negative terminal Vin−. The three-switch bridge arm comprises an upper switch Q1, a middle switch Q2 and a lower switch SR1, the upper switch Q1 and the middle switch Q2 are electrically connected to the upper node SWH1, and the middle switch Q2 and the lower switch SR1 are electrically connected to the lower node SWL1; the other three-switch bridge arm comprises an upper switch Q3, a middle switch Q4 and a lower switch SR2, the upper switch Q3 and the middle switch Q4 are electrically connected to the upper node SWH2, and the middle switch Q4 and the lower switch SR2 are electrically connected to the lower node SWL2. The transformer comprises two high-voltage windings TW11 and TW12, and two low-voltage windings TW21 and TW22, wherein the flying capacitor C1 and the high-voltage winding TW11 are connected in series between the upper node SWH1 and the lower node SWL2, and the flying capacitor C2 and the high-voltage winding TW12 are connected in series between the upper node SWH2 and the lower node SWL1. The second end of the low-voltage winding TW21 and the second end of the low-voltage winding TW22 are electrically connected to the center tap connecting point TL1 (forming a center tap connection). The first end of the low-voltage winding TW21 is electrically connected with the lower node SWL1. The first end of the low-voltage winding TW22 is electrically connected with the lower node SWL2. The second end of the inductor LW1 is electrically connected with the center tap connecting point TL1, and the first end of the inductor LW1 is electrically connected with the output positive terminal. The output capacitor Co is bridged between the output positive terminal Vo+ and the output negative terminal Vo−.

FIG. 1B is a schematic diagram of a control signal group of the six power switches of FIG. 1A. The control signal group includes a first control signal PWM1, a second control signal PWM2, a third control signal PWM3, and a fourth control signal PWM4. The first control signal PWM1 and the second control signal PWM2 are staggered by 180 degrees. The third control signal PWM3 is complementary to the first control signal PWM1, and the fourth control signal PWM4 is complementary to the second control signal PWM2. The first control signal PWM1 is used for controlling the turn-on and turn-off of the upper switch Q1 and the middle switch Q4, the second control signal is used for controlling the turn-on and turn-off of the upper switch Q3 and the middle switch Q2, the third control signal is used for controlling the turn-on and turn-off of the lower switch SR2, and the fourth control signal is used for controlling the turn-on and turn-off of the lower switch SR1. The interval between the moment 0 and the moment t6 is one switching period Ts of the power conversion circuit. The switching frequency of the upper switch Q1 or Q3 is defined as the switching frequency fsw of the power conversion circuit, and the turn-on duty ratio of the upper switch Q1 or Q3 is defined as the duty ratio D of the power conversion circuit.

The second end of the low-voltage winding TW21 and the first end of the low-voltage winding TW22 are dotted ends and are marked as point ends. The end, close to SWH1, of TW11 and the first end of TW22 are dotted ends and are marked as point ends, that is, TW11 and TW22 are connected in series in sequence; the end, close to SWH2, of TW12 and the first end of TW21 are dotted ends and are marked as non-point ends, that is, the windings TW12 and TW21 are also connected in series in sequence. The difference between the circuit topology of the embodiment and the prior art is that the capacitance of the flying capacitor C1 or C2 is large enough; and the inductor LW1 is a newly-added device. Therefore, the flying capacitor C1 or C2 with a large capacitance value can reduce the ripple voltage at the two ends of C1 or C2, the direct-current voltage is approximately Vin/2, and the resonance frequency between C1 or C2 and the leakage inductance of the transformer is much lower than the switching frequency fsw, so that the current waveform of the four windings of the transformer is close to the square wave rather than the sine wave. It is assumed that the ratio of the turns of the four windings of the transformer is TW11:TW12:TW21:TW22=N:N: 1:1. The voltage coupled to both ends of TW21 or TW22 is VIN/((2*(N+1)) due to the presence of the inductor LW1. As a result of the periodic switching of the lower switches SR1 and SR2, so that the voltage waveform of the center tap connecting point TL1 of the low-voltage winding TW21 and TW22 to the input negative terminal VIN− is 2*fsw, the duty ratio is 2*D, and the voltage amplitude is VIN/((2*(N+1)). The voltage waveform of the center tap connecting point TL1 is filtered by LW1 to generate a DC output voltage Vo. The voltage gain expression between the output voltage Vo and the input voltage Vin is Vo=D*Vin/(n+2). Therefore, the voltage gain adjustment capability between the output voltage Vo and the input voltage Vin can be obtained by adjusting the size of the duty ratio D.

The circuit topology shown in the embodiment not only has the gain adjustment capability between the output voltage Vo and the input voltage Vin, but also because the flying capacitor and the high-voltage winding are connected in series between the upper node and the lower node of the two bridge arms, the direct-current voltage drop across the flying capacitor is Vin/2, so that the voltage across the two ends of the high-voltage winding TW11 or TW12 is greatly reduced, and is only Vin*N/(2*(N+2)). Therefore, the number of turns of the high-voltage winding is greatly reduced, and the parasitic resistance and conduction loss of the high-voltage winding are greatly reduced. Even under the condition that the lower switch SR2 is disconnected, the current flowing through the TW11 flows through the low-voltage winding TW22 at the same time, so that the TW22 can share a part of current with TW21, and the conduction loss of the low-voltage winding is greatly reduced. Similarly, under the condition that the lower switch SR1 is disconnected, the conduction loss of the low-voltage winding is greatly reduced.

### Embodiment 2

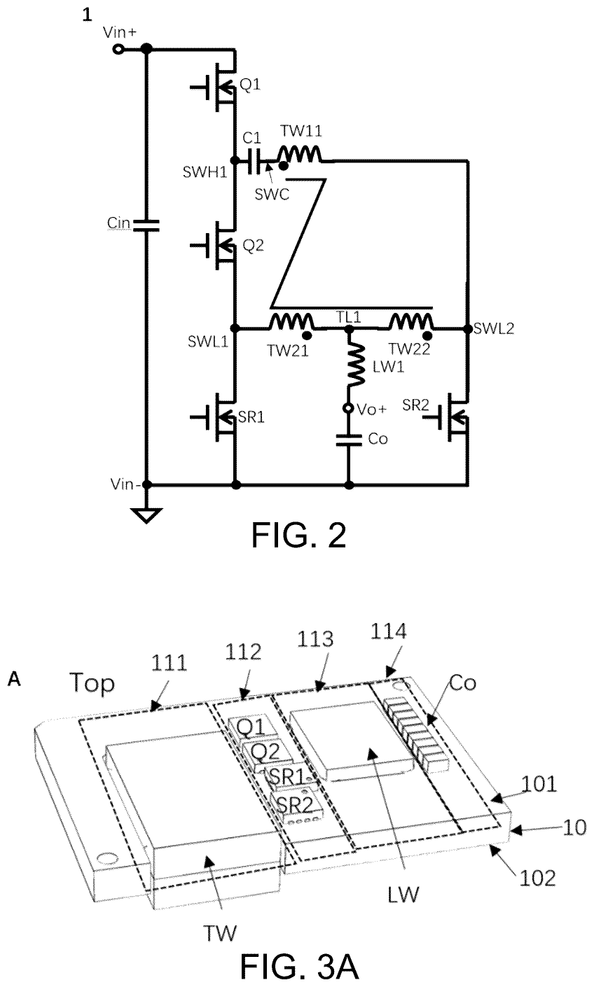

According to the power conversion circuit disclosed by the embodiment of the application, on the basis of the six-switch circuit topology shown in FIG. 1, the upper switch and the middle switch of one switch bridge arm are removed, and a flying capacitor and a high-voltage winding which are electrically connected in series are removed, as shown in FIG. 2. The power conversion circuit as shown in FIG. 2 comprises an input end Vin, an output end Vo, at least one input capacitor Cin, at least one output capacitor Co, a three-switch bridge arm, a lower switch SR2, a transformer, an inductor and a flying capacitor, wherein the input end Vin comprises an input positive terminal Vin+ and an input negative terminal Vin−, the output end Vo comprises an output positive terminal Vo+ and an output negative terminal Vo−, and the input negative terminal Vin− is short-circuited with the output negative terminal Vo−. The power conversion circuit 1 comprises a three-switch bridge arm, a lower switch, a flying capacitor, a transformer and an inductor. The three-switch bridge arm comprises an upper switch Q1, a middle switch Q2 and a lower switch SR1, wherein the upper switch Q1 and the middle switch Q2 are electrically connected to the upper node SWH1, the middle switch Q2 and the lower switch SR1 are electrically connected to the lower node SWL1 in series, the drain electrode of the upper switch Q1 is electrically connected to the input positive terminal Vin+, and the source electrode of the lower switch SR1 and the source electrode of the lower switch SR2 are electrically connected to the input negative terminal Vin−; and the drain electrode of the lower switch SR2 is electrically connected with the lower node SWL2. The transformer TW comprises three coupled windings, which are a high-voltage winding TW11 and two low-voltage windings TW21 and TW22, respectively, wherein after the high-voltage winding TW11 is electrically connected in series with the flying capacitor C1, the high-voltage winding TW11 is bridged between the upper node SWH1 and the lower node SWL2. The second end of the low-voltage winding TW21 and the second end of the low-voltage winding TW22 are electrically connected to the center tap connecting point TL1, the first end of the low-voltage winding TW21 is electrically connected with the lower node SWL1, the first end of the low-voltage TW22 is electrically connected with lower node SWL2. The turn number ratio of the windings TW11, TW21 and TW22 is N: 1:1. The second end of the inductor LW1 is electrically connected with the center tap connecting point TL1, and the first end of the inductor LW1 is electrically connected with the output positive terminal Vo+. The output capacitor Co is bridged between the output positive terminal Vo+ and the input negative terminal Vin−, and the input capacitor Cin is connected across the input positive terminal Vin+ and the input negative terminal Vin. The power conversion circuit shown in FIG. 2 may also be a schematic diagram of the control signal group shown in FIG. 1B. The first control signal PWM1 is used for controlling the turn-on and turn-off of the upper switch Q1, the second control signal PWM2 is used for controlling the turn-on and turn-off the middle switch Q2, the third control signal is used for controlling the turn-on and turn-off of the lower switch SR2, and the fourth control signal is used for controlling the turn-on and turn-off of the lower switch SR1. The interval between the moment 0 and the moment t6 is one switching period Ts of the power conversion circuit, the switching frequency of the upper switch Q1 is defined as the switching frequency fsw of the power conversion circuit, and the turn-on duty ratio of the upper switch Q1 is defined as the duty ratio D of the power conversion circuit.

The second end of the low-voltage winding TW21 and the first end of the low-voltage winding TW22 are dotted ends and are marked as point ends. The end, close to SWH1, of TW11 and the first end of TW22 are dotted ends and are marked as point ends, that is, TW11 and TW22 are connected in series in sequence. It is assumed that the ratio of the number of turns of the three windings of the transformer is TW11:TW21:TW22=N: 1:1, and the voltage coupled from the two ends of TW21 or TW22 is VIN/((2*(N+1)) due to the existence of the inductor LW1. Due to periodic switching of SR1 and SR2, the voltage waveform of the center tap connecting point TL1 to the input negative terminal VIN− is 2*fsw, the duty ratio is 2*D, and the voltage amplitude is VIN/((2*(N+1)). After the voltage waveform of the center tap connecting point TL1 is filtered by the inductor winding LW1, a direct-current output voltage Vo is generated. The voltage gain expression between the output voltage Vo and the input voltage Vin is Vo=D*Vin/(n+2). Therefore, the voltage gain adjustment capability between the output voltage Vo and the input voltage Vin can be obtained by adjusting the size of the duty ratio D. Because the flying capacitor and the high-voltage winding are connected in series between the upper node and the lower node of the two bridge arms, the direct-current voltage across the flying capacitor is Vin/2, so that the voltage borne by the two ends of the high-voltage winding TW11 or TW12 of the transformer is greatly reduced, and is only Vin*N/(2*(n+2)). Therefore, the number of turns of the high-voltage winding is greatly reduced, and the parasitic resistance and conduction loss of the high-voltage winding are greatly reduced. Even under the condition that the lower switch SR2 is disconnected, the current flowing through the TW11 flows through the low-voltage winding TW22 at the same time, so that the TW22 can share a part of current, and the conduction loss of the low-voltage winding is greatly reduced. Similarly, under the condition that the lower switch SR1 is disconnected, the conduction loss of the low-voltage winding is greatly reduced.

Compared with the circuit topology in FIG. 1A, the position of the power switch device is four, and correspondingly, the position of the flying capacitor is reduced from two to one, and the number of the high-voltage windings is reduced from two to one. In this way, the number of the power switch device and the driving circuit thereof is reduced to ⅔, the circuit structure is simplified, the number of devices is reduced, and the circuit topology is particularly suitable for occasions with low power and high-power-density.

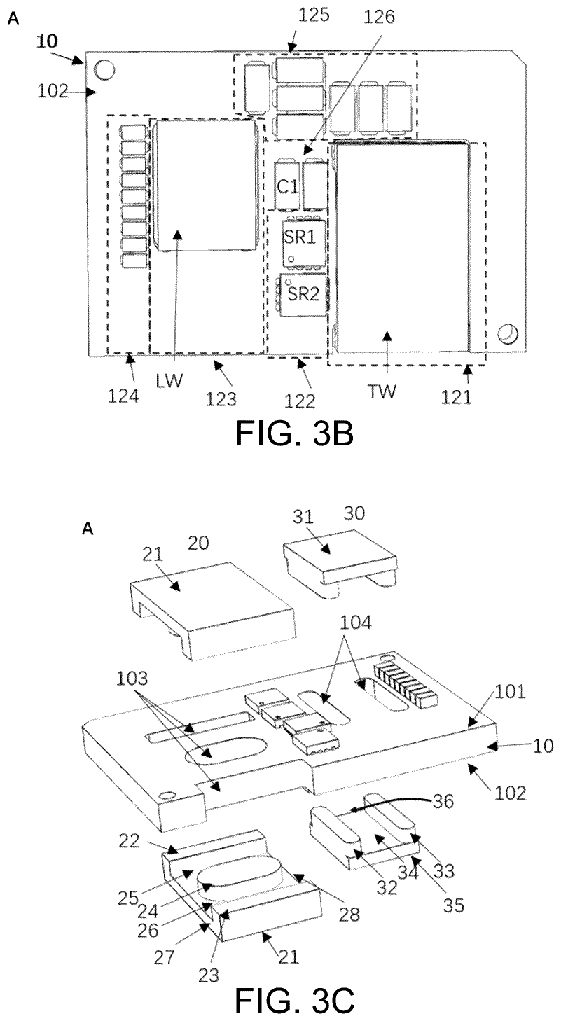

FIG. 3A to FIG. 3E show the structural layout of the power conversion apparatus A applying the power conversion circuit 1 in FIG. 2, the power conversion device A comprises a winding substrate 10, a transformer assembly TW, an inductance assembly LW, a plurality of switches (including an upper switch, a middle switch and a lower switch), at least one input capacitor Cin and at least one output capacitor Co. The winding substrate 10 comprises a first surface 101 and a second surface 102 opposite to each other, a transformer magnetic core hole groove 103 and an inductor magnetic core hole groove 104, wherein the magnetic core hole grooves 103 and 104 penetrate through the first surface 101 and the second surface 102. The first surface 101 comprises a transformer area 111, a switch area 112, an inductance area 113 and an output area 114. The transformer area 111, the switch area 112, the inductance area 113 and the output area 114 are sequentially arranged in the same direction. The partial transformer assembly TW is arranged in the transformer area 111, the upper switch Q1, the middle switch Q2 and the at least one lower switch SR1/SR2 are arranged in the switch area 112, the partial inductor component LW is arranged in the inductor area 113, and the at least one output capacitor Co is arranged in the output area 114. The second surface comprises a transformer area 121, a switch area 122, an inductor area 123 and an output area 124. The transformer area 121, the switch area 122, the inductor area 123 and the output area 124 are sequentially arranged in the same direction, the partial of the transformer assembly TW is arranged in the transformer area 121, the at least one lower switch SR1/SR2 is arranged in the switch area 122, the partial inductor assembly LW is arranged in the inductor area 123, and the at least one output capacitor Co is arranged in the output area 124. Furthermore, the transformer area 121, the switch area 122, the inductor area 123 and the output area 124 of the second surface are in one-to-one correspondence with the transformer area 111, the switch area 112, the inductor area 113 and the output area 114 of the first surface in a one-to-one correspondence mode. The second surface further comprises an input capacitor area 125 and a flying capacitor area 126, the at least one input capacitor Cin is arranged in the input capacitor area 125, and the at least one flying capacitor area C1 is arranged in the flying capacitor area 126.

The projection of at least one lower switch SR1 arranged on the first surface 101 on the first surface 101 overlaps with the projection of the at least one lower switch SR1 arranged on the second surface 102 on the first surface 101, and the projection of the at least one lower switch SR2 arranged on the first surface 101 on the first surface 101 overlaps with the projection of the at least one lower switch SR2 arranged on the second surface 102 on the first surface 101; and the projection of the at least one output capacitor Co arranged on the first surface 101 on the first surface 101 overlaps with the projection of the at least one output capacitor Co arranged on the second surface 102 on the first surface 101.

The transformer assembly TW comprises a transformer core 20, a high voltage winding TW11, two low voltage windings TW21 and TW22. The high voltage winding TW11, and two low voltage windings TW21 and TW22 disposed on the winding substrate 10. The transformer magnetic core 20 comprises two transformer magnetic substrates 21, a first side column 22, a second side column 23 and a middle column 24; the first side column 22, the middle column 24 and the second side column 23 are arranged between the two transformer magnetic substrates 21 and are arranged in the same sequence. The transformer hole groove 103 is used for the first side column 22, the middle column 24 and the second side column 23, and the two transformer magnetic substrates 21 are buckled with the winding substrate 10 from the first surface 101 and the second surface 102 respectively. The structure of the transformer magnetic core 20 is shown in FIG. 3C, part of the first side column 22, part of the second side column 23 and part of the middle column 24 are integrally formed with one transformer magnetic substrate 21; the other part of the first side column 22, the other part of the second side column 23 and the other part of the middle column 24 and the other transformer magnetic substrate 21 are integrally formed; or the first side column 22, the second side column 23 and the middle column 24 are integrally formed with one transformer magnetic substrate 21, and the other transformer magnetic substrate 21 is integrally formed separately; or the first side column 22, the second side column 23, the middle column 24 and the two transformer magnetic substrates 21 can also be integrally formed separately.

The inductor assembly LW includes an inductor core 30, an inductor winding LW1. The inductor winding LW1 is disposed in the winding substrate 10. The inductor magnetic core 30 includes two inductive magnetic substrates 31, a first winding column 32, and a second winding column 33. The first winding column 32 and the second winding column 33 are disposed between the two inductor magnetic substrates 31. The inductor hole slot 104 is configured for the first winding column 32 and the second winding column 33 to pass through, and the two inductor magnetic substrates 31 are respectively buckled with the winding substrate 10 from the first surface 101 and the second surface 102. As shown in FIG. 3C for the structure of the inductor core 30, part of the first winding column 32 and part of the second winding column 33 are integrally formed with one inductor magnetic substrate, and the other part of the first winding column 32 and the other part of the second winding column 33 are integrally formed with the other inductor magnetic substrate; alternatively, the first winding column 32 and the second winding column 33 are integrally formed with one inductor magnetic substrate 31, and the other inductor magnetic substrate 31 is integrally formed; or the first winding column 32 and the second winding column 33 may also be integrally formed with the two inductor magnetic substrates 31 separately.

As shown in FIG. 3D and FIG. 3E, the power conversion device A further includes a heat dissipation substrate 40, and the heat dissipation substrate is assembled or fixed on the first surface 101 of the winding substrate 10. The specific assembly or fixing method is to fix the heat dissipation substrate 40 on the winding substrate 10 through screws passing through the screw mounting hole 43 of the substrate 10. On one hand, part of the bottom surface of the heat dissipation substrate 40 is attached to the area 42 on the first surface 101 by means of heat conduction adhesive, and heat generated by the winding substrate or heat generated by other components is conducted to the heat dissipation substrate 40 through the winding substrate and the heat conduction adhesive, so that the thermal resistance between the winding substrate 10 and the heat dissipation substrate 40 is effectively reduced. On the other hand, part of the bottom surface of the heat dissipation substrate 40 is attached to the top surface area 41 of the part of components through the heat conduction adhesive, and heat generated by some components is directly conducted to the heat dissipation substrate 40 through the heat conduction adhesive, so that the thermal resistance between the component and the heat dissipation substrate 40 is effectively reduced. A top surface of the heat dissipation substrate 40 is configured to mount a heat dissipation apparatus. In the assembly process of the power conversion device, after the winding substrate or part of the components needs to be covered with the heat conduction adhesive, the heat dissipation substrate 40 is covered on the heat conduction adhesive, and finally the heat dissipation substrate 40 is fixed on the winding substrate 10 by using a screw passing through the screw mounting hole 43. The entire power conversion device with the heat dissipation substrate 40 may go through the reflow soldering process when the power conversion device is assembled with client's board. When the reflow soldering is performed on the client side, if the position of the heat conduction adhesive is adjacent to or covers the position of the solder joint, the thermal expansion and contraction or explosion of the air inside the heat conduction adhesive may be squeezed to the melted soldering or even generate solder beads, which affects the production quality and reliability of the power conversion device. Therefore, the top surface area 41 of the component needs to select the top surface of the heat generating component but does not include the position of the solder joint of the heat generating component, such as the top surface of the transformer magnetic core, the top surface of the inductor magnetic core or the top surface of the switch, but not the solder joint position of the switch. And the winding substrate region 42 cannot include solder joints; that is, the influence of the thermal conductive adhesive on the reliability of the solder joint can be avoided, and the heat conductor adhesive can be used to effectively reduce the interface thermal resistance between the heat dissipation substrate 40 and the winding substrate 10 or components, thereby achieving the purpose of effective heat dissipation and reliable production.

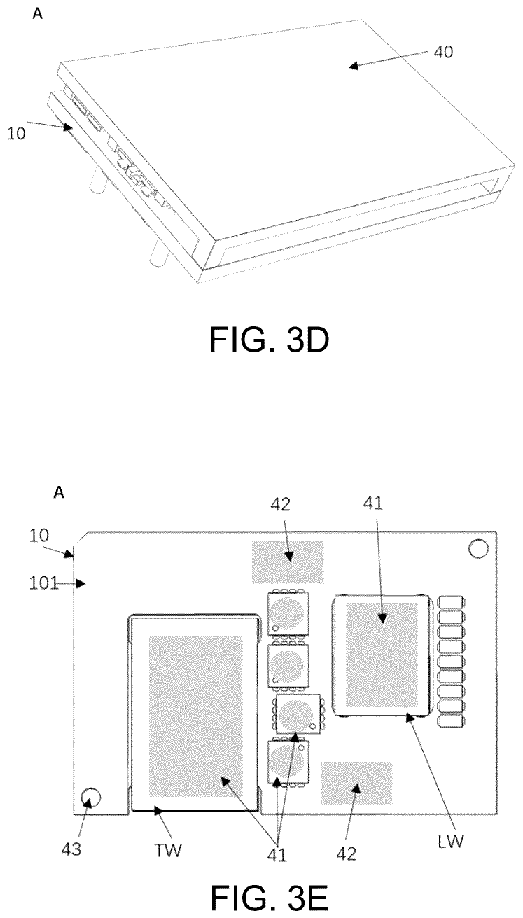

The winding diagram of the transformer and the inductor in the power conversion device A is shown as shown in FIG. 4A to FIG. 4B, a channel between the first side column 22 and the middle column 24 in the transformer magnetic core 20 is defined as a first transformer winding channel 25. A channel between the second side column 23 and the middle column 24 is defined as a second transformer winding channel 26. The transformer magnetic core 20 further includes a first transformer winding channel side 27 and a second transformer winding channel side 28 opposite to each other. The first transformer winding channel 25 and the second transformer winding channel 26 pass through the first transformer winding channel side 27 and the second transformer winding channel side 28. Similarly, as shown in FIG. 4B, a channel between the first winding column 32 and the second winding column 33 in the inductor magnetic core 30 is defined as an inductor winding channel 34. The inductor magnetic core 30 comprises a first inductor winding channel side 35 and a second inductor winding channel side 36 opposite to each other. The inductor winding channel 34 passes through the first inductor winding channel side 35 and the second inductor winding channel side 36.

FIG. 4A shows a layout diagram of the TOP surface of the power conversion device and a winding manner of the low-voltage windings TW21 and TW22 in the transformer assembly TW. The second end of the low voltage winding TW21 and the second end of the low voltage winding TW22 are shorted to the center tap connection point TL1. The center tap connection point TL1 is adjacent to the second transformer winding channel side 28, and the wiring forming the center tap connecting point TL1 extends to the first inductor winding channel side 35. The low-voltage winding TW21 is wound around the middle column 24 in a clockwise direction from the second end (the center tap connection point TL1) to the first end (the lower node SWL1), for example, as shown in FIG. 4A, the first end of the low-voltage winding TW21 is short-circuited with the lower switch SR1. The low-voltage winding TW22 is wound around the middle column 24 in a counterclockwise direction from the second end (the center tap connection point TL1) to the first end (the lower node SWL2), for example, as shown in FIG. 4A, the first end of the low-voltage winding TW22 is short-circuited with the lower switch SR2. In this embodiment, the switch area 112 is adjacent to the second transformer winding channel side 28, and the lower switches SR1 and SR2 are respectively disposed adjacent to the first winding channel port and the second winding channel port, so that an alternating current loop formed by the low voltage winding and the lower switch is minimum, and parasitic parameters of the alternating current loop are reduced, thereby reducing an alternating current loss of the low voltage winding loop.

FIG. 4B shows a layout diagram of the BOTTOM surface of the power conversion device and a winding mode of the high-voltage winding TW11 in the transformer assembly TW. The first end of the high-voltage winding TW11 and the flying capacitor C1 are electrically connected to the point SWC, and a second end of the high-voltage winding TW11 is electrically connected to the lower node SWL2. The high voltage winding TW11 is wound around the middle column 24 in a counterclockwise direction from the first end (point SWC) to the second end (lower node SWL2), as shown in FIG. 4B. In this embodiment, the high-voltage winding TW11 is wound two circles around the middle column 24, but it is not limited thereto. The source terminal of the lower switch SR1 and the source terminal of the lower switch SR2 are electrically connected to the negative voltage terminal of the input capacitor Cin, and the wiring of the lower switch SR1 and the lower switch SR2 is a part of wiring of the VIN−. The projection of the input capacitor Cin arranged on the second surface 102 on the horizontal plane is adjacent to the projection of the upper switch Q1 arranged on the first surface 101 on the same horizontal plane, so that the positive voltage terminal of the input capacitor Cin is connected to the drain of the upper switch Q1 arranged on the first surface 101 by the shortest distance through the via hole, and the source of the upper switch Q1 is connected to the flying capacitor C1 on the second surface 102 by the shortest distance through the via hole.

In this embodiment, on the first surface 101, the switch region 112 is disposed between the transformer region 111 and the inductor region 113. On the second surface 102, the switch region 122 is disposed between the transformer region 121 and the inductor region 123, the flying capacitor region 126 is disposed between the transformer region 121 and the inductor region 123, and the flying capacitor C1 is adjacent to the second transformer winding channel side 28, so that an alternating current loop formed by the high voltage winding, the flying capacitor C1, the low voltage winding, the lower switch SR1, the input capacitor Cin and the upper switch Q1 is minimum, and parasitic parameters of the alternating current loop are reduced, thereby the alternating current loss of the high voltage winding is reduced too.

In a conventional half-bridge circuit or a full-bridge circuit, during the conduction of the upper switch or the lower switch of the primary half-bridge arm, the ampere-turn number of the current flowing from the high-voltage winding of the transformer is equal to the ampere-turn number of the current flowing out from a certain low-voltage winding. It is usually set that the ratio of the number of the wiring layers of each low-voltage winding to the number of the wiring layers of the high-voltage winding is close to 1, so that the loss of each low-voltage winding is approximately equal to that of the high-voltage winding, and the minimum sum loss of the low-voltage winding and the high-voltage winding of the transformer is obtained. Referring to the power conversion circuit shown in FIG. 2, the first end (point SWC) of the high-voltage winding TW11 and the second end of the low-voltage winding TW21 and the first end of the low-voltage winding TW22 are dotted terminals and are marked as point ends. In an interval in which the upper switch Q1 is turned on, the sum of the ampere-turns of the current flowing into the first end of the high-voltage winding TW11 and the ampere-turns of the current flowing into the first end of the low-voltage winding TW22 is equal to the ampere-turns of the current flowing out from the second end of the low-voltage winding TW21. In this embodiment, the windings of the transformer are all implemented inside or on the surface wiring layer of the winding substrate 10. And the ratio of the turns of the high-voltage winding to the turns of the two low-voltage windings is TW11:TW21:TW22=N: 1:1. When the upper switch Q1 and the lower switch SR1 are turned on, the three windings are connected in series to withstand 0.5 times of the input voltage. The number of wiring layers of the two low-voltage windings is the same or approximately the same, and the ratio of the number of wiring layers of each low-voltage winding to the number of wiring layers of the high-voltage winding is greater than 1; even in some embodiments, the ratio of the number of wiring layers of each low-voltage winding to the number of wiring layers of the high-voltage winding may be greater than or equal to 1.5. In this embodiment, the ratio of the number of wiring layers of each low-voltage winding to the number of wiring layers of the high-voltage winding is 2, but not limited thereto. The ratio of the number of wiring layers of each low-voltage winding to the number of the wiring layers of the high-voltage winding may also be approximately (N+2)/N. Through the arrangement of the number of the winding layers, so that the loss of each low-voltage winding is approximately equal to that of the high-voltage winding, thereby obtaining the advantage of the minimum sum loss of the low-voltage winding and the high-voltage winding of the transformer.

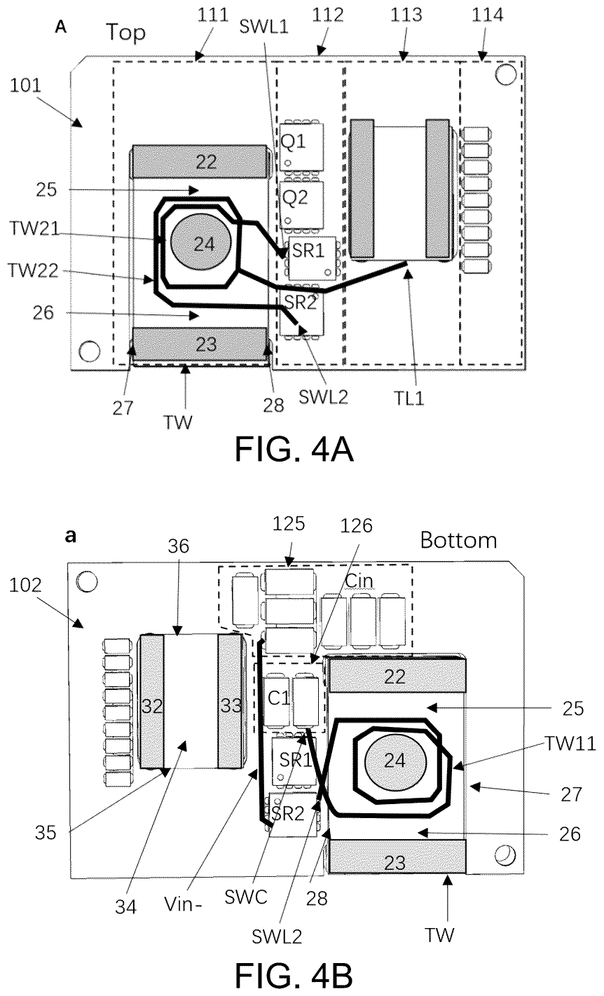

FIG. 5A to FIG. 5B show a schematic diagram of a local layout of a TOP surface of the power conversion device and a winding manner of the inductor winding LW1 in the inductor assembly LW. In this embodiment, the inductor winding LW1 includes an inductor inner layer winding LW11 and the inductor surface layer winding LW12. The inductor winding LW1 (ie, the center tap connecting point TL1, defined as an inductor input end) is connected to the second end of each low voltage winding through an inner layer wiring or a via hole in the winding substrate, and the inductor inner layer winding LW11 starts from the inductor input end, passes through the inductor winding channel 34 from the first inductor winding channel side 35 to the second inductor winding channel side 36, and is divided into two branches, wherein the first branch LW11-1 is wound around the first winding column 32 in a counterclockwise direction to reach an internal through hole area LVia1 disposed on the first inductor winding channel side 35. Meanwhile, the second branch LW11-2 is wound around the second winding column 33 in the clockwise direction to reach the internal through hole area LVia2 arranged on the first inductor winding channel side 35. The inductor surface layer winding LW12 comprises a surface layer through hole area LVia3 and a surface layer through hole area LVia4, wherein the surface layer through hole area LVia3 and the internal through hole area LVia1 are electrically connected through a through hole formed in the winding substrate, and the surface layer through hole area LVia4 and the internal through hole area LVia2 are electrically connected through a through hole formed in the winding substrate. The inductor surface layer winding LW12 is disposed on the first surface 101 of the winding substrate 10, and may be a surface layer wiring of the PCB, or may be a surface layer welding copper bar of the PCB. The inductor surface layer winding LW12 starts from the surface layer through hole area LVia3 and the surface layer through hole area LVia4, passes through the inductor winding channel 34 again from the first inductor winding channel side 35 to the second inductor winding channel side 36, and is electrically connected with the positive voltage end of the output capacitor Co to form the output positive terminal Vo+ of the power conversion device A. The end, electrically connected with the output capacitor Co, of the inductor winding LW1 is defined as the inductor output end. Here, the input end and the output end of the inductor winding are respectively arranged on two opposite sides of the inductor magnetic core, and the inner through hole region of the inner layer winding and the surface layer through hole region of the surface layer winding and the input end of the inductor are located on the same side of the inductor magnetic core. In the winding manner of the inductor winding disclosed in this embodiment, the first branch and the second branch surrounding the outer side of the magnetic core are only disposed on the inner layer of the winding substrate, so that more components can be provided on the surface of the winding substrate and adjacent to the outer side of the inductor magnetic core (that is, the projection of the components on the internal winding of the inductor overlaps with the first branch or the second branch). As shown in FIG. 5B, the switch and the output capacitor Co, thereby more effectively utilizing the surface of the winding substrate and reducing the volume of the power conversion apparatus.

In the above embodiment, the inductor internal winding passes through the inductor winding channel and is surrounded the outer side of the inductor magnetic core; and the inductor surface winding only passes through the inductor winding channel and does not occupy the area of the surface of the winding substrate on the outer side of the inductor magnetic core; and more components can be arranged in the surface area of the winding substrate on the outer side of the inductor magnetic core while the required inductor performance requirement is met, so that the requirement of the compact power conversion device is met.

### Embodiment 3

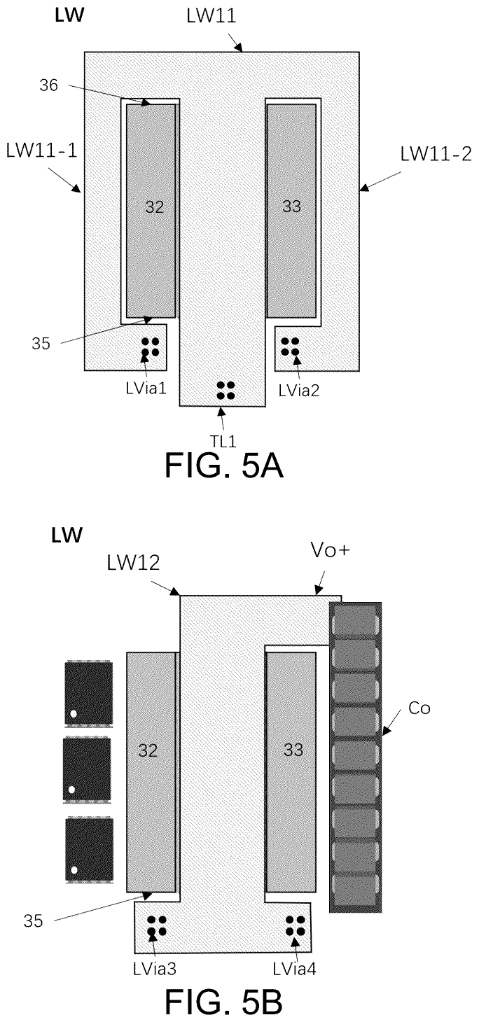

FIG. 6A to FIG. 6B are schematic diagrams of another power conversion circuit 2, Referring to FIG. 2, the difference between the power conversion circuit 2 and the power conversion circuit 1 is that the inductor assembly LW is removed, and the second end of the low-voltage winding TW21 and the second end of the low-voltage winding TW22 are electrically connected to the output positive terminal Vo+ of the power conversion circuit 2. As shown in FIG. 6B, in the winding manner of the transformer assembly TW, the high-voltage winding TW11 is wound clockwise around the middle column 24 from the first end (point SWC) to the second end (the lower node SWL 2). In this embodiment, the high-voltage winding TW11 is wound around the middle column 24, and the first end and the second end of the high-voltage winding TW11 are both located on the first transformer winding channel side 27. The low voltage winding TW21 passes through the second transformer winding channel 26 from the first end (point SWL1) to the second end (the output positive terminal Vo+). The low-voltage winding TW22 passes through a transformer winding channel 25 from the first end (point SWL2) to the second end (the output positive terminal Vo+). The second ends of the low-voltage windings TW21 and TW22 are shorted to the output positive terminal Vo+, and the first end and the second end of each low-voltage winding are respectively located on two opposite sides of the transformer magnetic core, the path of the low-voltage winding in this embodiment is short, the parasitic resistance on the winding is small, and the conduction loss is small. The DC flux generated by the low voltage winding TW21 on the middle column 24 and the DC flux generated by the low voltage winding TW22 on the middle column 24 counteract. the voltage across the low-voltage winding TW21 and the voltage across the low-voltage winding TW22 are staggered by 180 degrees, so that the alternating-current magnetic flux generated by the low-voltage winding TW21 on the middle column 24 and the alternating-current magnetic flux generated by the low-voltage winding TW22 on the middle column 24 are subtracted according to the phase, so that the alternating-current magnetic flux flowing through the middle column is greater than the alternating-current magnetic flux flowing through each side column. In this embodiment, the transformer magnetic core and the inductor magnetic core are combined into one, which reduces the volume occupied by the magnetic element in the power conversion device, and is suitable for applications with the requirement on the high power density of the power conversion device and the requirement of the low output ripple current. In addition, because the switching devices connected to the high-voltage winding and the low-voltage winding, and the output positive terminals Vo+ are arranged on two sides of the magnetic core, the advantages are that the second end of the low-voltage winding is connected to the output positive terminal with the shortest distance; The switching devices connected to the high-voltage winding and the low-voltage winding are arranged on the same side of the magnetic core, so that the alternating-current loop formed by the low-voltage winding and the alternating-current loop formed by the high-voltage winding are minimized, and the loss of the alternating-current loop is reduced.

Technical features such as the layout of the power conversion device and the control of the power conversion circuit disclosed in Embodiment 2 are also applicable to Embodiment 3, and details are not described herein again.

### Embodiment 4

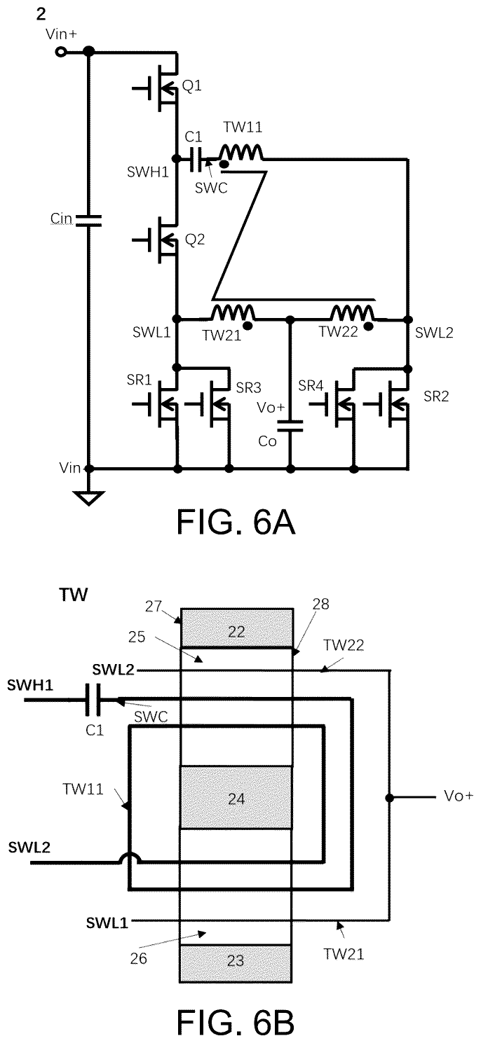

FIG. 7A to FIG. 7B are schematic diagrams of another power conversion circuit 3. With reference to FIG. 6A, the difference between the power conversion circuit 3 and the power conversion circuit 2 is that a high-voltage winding TW13 is added. The second end of the high-voltage winding TW11 is electrically connected in series with the first end of the TW13, and is connected in series with the flying capacitor C1 and then bridged between the upper node SWH1 and the lower node SWL2. The second end of the high-voltage winding TW13 is electrically connected to the lower node SWL2. The winding mode of the transformer assembly TW shown in FIG. 7B. The high-voltage winding TW11 is wound around the first side column 22 in clockwise direction from the first end to the second end, and is electrically connected to the first end of the high-voltage winding TW13 after passing through the first transformer winding channel 25 from the second transformer winding channel side 28 to the first transformer winding channel side 27. The high voltage winding TW13 is wound around the second side column 23 in a second direction (such as counterclockwise) from the first end to the second end (point SWL2), and is electrically connected to the first end (point SWL2) of the low voltage winding TW22 after passing through the second transformer winding channel 26 from the second transformer winding channel side 28 to the first transformer winding channel side 27. In this embodiment, the first end and the second end of the high-voltage winding TW11 and the first end and the second end of the high-voltage winding TW13 are both located on the first transformer winding channel side 27.

The low-voltage winding TW22 is wound from the first end (point SWL2) to the second end (the output positive terminal Vo+), is wound around the first side column 22 in a first direction (such as clockwise direction), and passes through the first transformer winding channel 25 from the second transformer winding channel side 28 to the first transformer winding channel side 27, and is electrically connected to the second end of the low-voltage winding W21. The low voltage winding TW21 is wound around the second side column 23 in a second direction (such as counterclockwise) from the second end (the output positive terminal Vo+) to the first end (point SWL1), and passes through the second transformer winding channel 26 from the second transformer winding channel side 28 to the first transformer winding channel side 27. In this embodiment, the direct current flux generated by the low voltage winding TW21 on the middle column 24 and the direct current magnetic flux generated by the low voltage winding TW22 on the middle column 24 are superimposed. The voltage across the low-voltage winding TW21 and the voltage across the low-voltage winding TW22 are staggered by 180 degrees, so that the alternating-current magnetic flux generated by the low-voltage winding TW21 on the middle column 24 and the alternating-current magnetic flux generated by the low-voltage winding TW22 on the middle column 24 are superposed according to the phase, so that the alternating-current magnetic flux flowing through the middle column is smaller than the alternating-current magnetic flux flowing through each side column. In this embodiment, the transformer magnetic core and the inductor magnetic core are combined into one, which reduces the volume occupied by the magnetic member in the power conversion device, and reduces the output ripple current through the winding manner of the winding. Compared with the power conversion circuit 2, the parasitic resistance of the low-voltage winding is increased, and the conduction loss is also increased. In addition, since the switching devices connected to the high-voltage winding and the low-voltage winding are arranged on the same side of the magnetic core, the alternating-current loop formed by the low-voltage winding and the alternating-current loop formed by the high-voltage winding can be minimized, thereby reducing the loss of the alternating-current loop.

### Embodiment 5

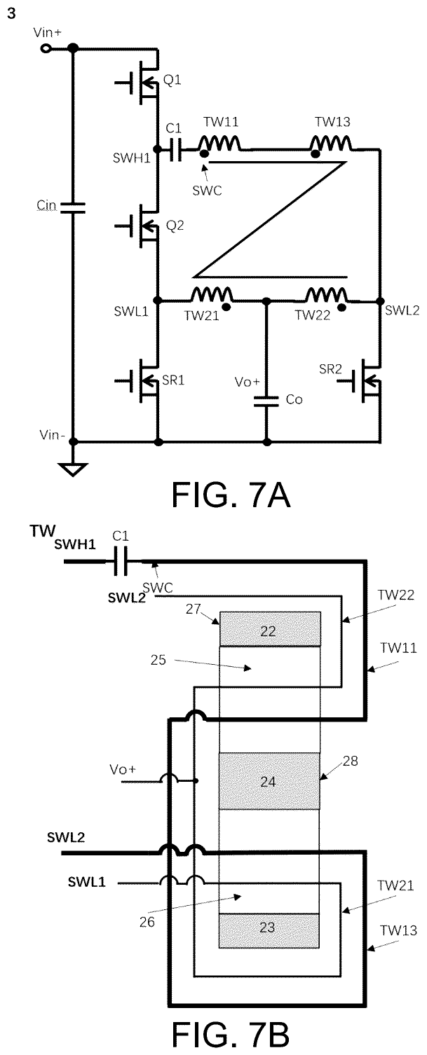

The power conversion circuits 1, 2 and 3 disclosed in the above embodiments all include a three-switch bridge arm, so the corresponding power conversion device may further include a driving power supply unit 50. As shown in FIG. 8, the driving voltage of the lower switch SR1 is powered by the first voltage Vcc1, the driving voltage of the upper switch Q1 and the middle switch Q2 in the three-switch bridge arm is powered by the second voltage Vcc2. The second voltage Vcc2 is greater than the first voltage Vcc1. The second voltage Vcc2 is electrically connected to the driving circuit of the middle switch Q2 through the first bootstrap diode D1, and the bootstrap capacitor Cb1 of the middle switch Q2 is charged. Further, the second voltage VCC2 is electrically connected to the driving circuit of the upper switch Q1 through the first bootstrap diode D1 and the second bootstrap diode D2, and charges the bootstrap capacitor Cb2 of the upper switch Q1. The second voltage VCC2 is greater than the first voltage VCC1, so that the driving circuit of the upper switch Q1 obtains a sufficiently high supply voltage, which can reduce the on-resistance of the upper switch Q1, thereby reducing the conduction loss of the upper switch and improving the efficiency of the power conversion apparatus.

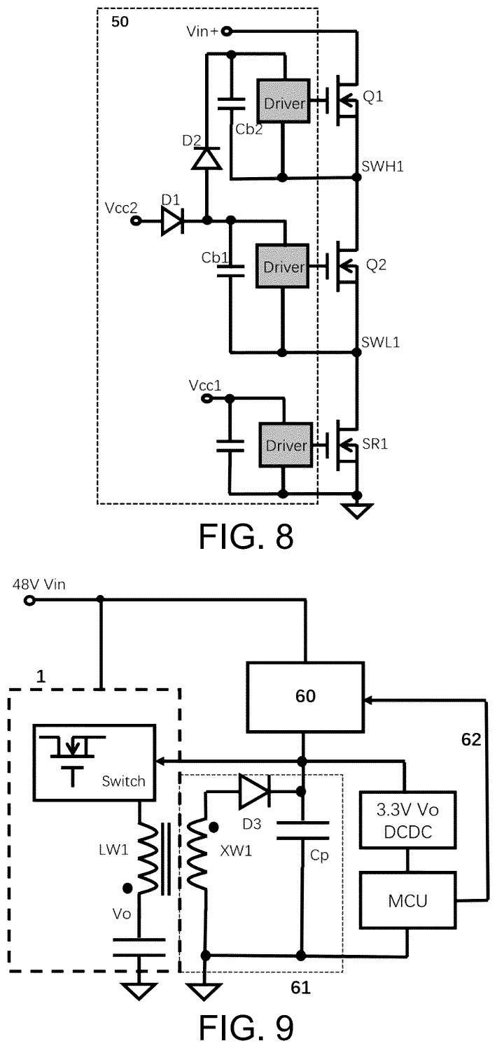

In some other embodiments, the power conversion apparatus further includes a starting power supply unit 60 and a working power supply unit 61, as shown in FIG. 9. The input terminal of the start power supply unit 60 is electrically connected to the bus voltage of 48V Vin, and the output terminal is electrically connected to a 3.3 V output power supply unit. When the power conversion circuit 1 of FIG. 2 is in a standby state or a starting state, the power supply unit 60 is started to supply power to the output voltage 3.3V of power supply unit, so as to supply power to the microprocessor MCU, and at the same time, the power supply unit 50 can be powered. In the standby state, the power supply unit 60 is to supply power to the MCU to maintain normal operation of the MCU communication interface, so that the power conversion circuit 1 can maintain communication with the outside in a standby state. In this embodiment, in the standby state, the power consumption of the MCU is small enough, so that the starting power supply unit 60 may be implemented by using a linear stabilized voltage source, that is, an LDO. Compared with the manner in which the starting power supply unit 60 is implemented by using a switching power supply, the starting power supply unit 60 is implemented by using a linear voltage stabilizing power supply, that is, the circuit for starting the power supply unit is simplified, the power consumption of the starting power supply unit is limited, and the size of the starting power supply unit is reduced. When the start of the power conversion circuit 1 ends, the microprocessor MCU generates a control signal 62 to control the start power supply unit 60 to stop working. The working power supply unit 61 includes a coupling winding XW1, a power supply diode D3, and at least one power supply capacitor Cp, wherein the coupling winding XW1 is coupled to an output inductor LW1 in the power conversion circuit 1, or is coupled to a winding electrical connected with Vo+. The coupling voltage is rectified and filtered by the power supply diode D3 and the power supply capacitor Cp, and an output end of the working power supply unit 61 is shorted to an output end of the starting power supply unit 60. When the power conversion circuit 1 works normally, the control signal 62 controls the starting power supply unit 60 to stop working, the working power supply unit 61 starts to supply power, and supply power to the microprocessor MCU with the output voltage 3.3V, and supply power to the driving power supply unit 50. Because the working current of the power conversion circuit 1 in the standby state is small, when the power conversion circuit 1 is in the starting state, although the working current is increased, the starting time is relatively short, the temperature rise of the starting power supply unit 60 is limited, so the volume occupied by the starting power supply unit 60 is not large. After the power conversion circuit enters the steady-state operation, the coupling winding XW1 in the working power supply unit 61 may provide a stable output, and the conversion efficiency is high, thereby improving the overall efficiency of the power conversion apparatus. The voltage output by the output power supply unit herein is not limited to 3.3V, and can be changed correspondingly according to actual requirements.

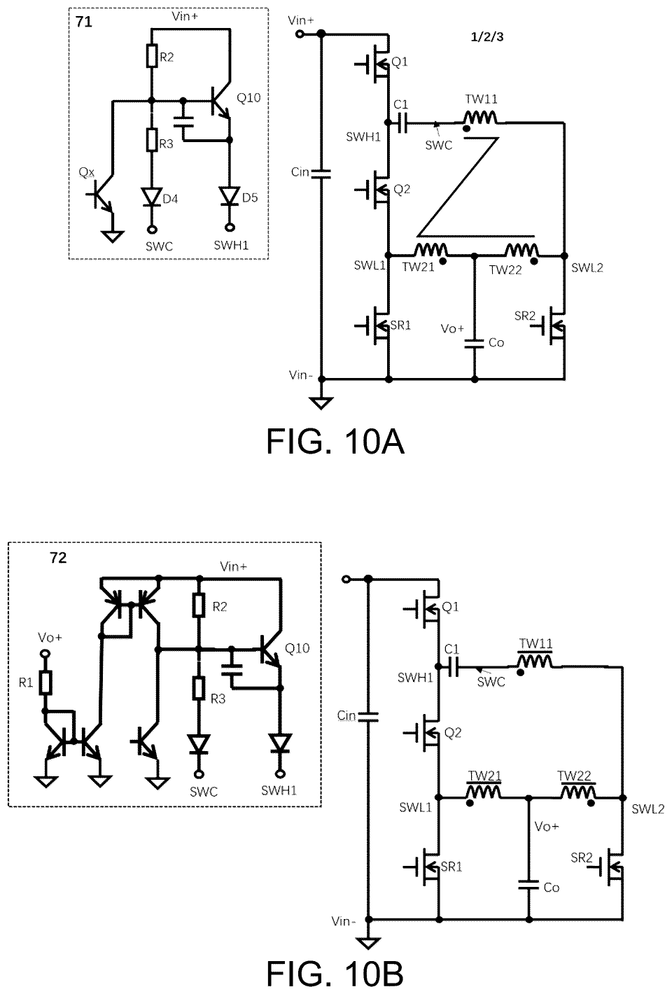

In some other embodiments, the power conversion apparatus further includes a pre-charging unit 71, as shown in FIG. 10A. The pre-charging unit 71 is applicable to the power conversion circuit 1/2/3 of FIG. 2, FIG. 6A and FIG. 7A. The pre-charging unit 71 includes a charging triode Q10, an enabling triode QX, a pre-charging resistor R2 and R3, and pre-charging diodes D4 and D5. The collector of the charging triode Q10 is electrically connected to the input positive terminal Vin+ of the power conversion circuit, the emitter is electrically connected to the positive electrode of the pre-charging diode D5, and the negative electrode of the pre-charging diode D5 is electrically connected to the upper node SWH1. The first terminal of the pre-charging resistor R2 is electrically connected to the input positive terminal Vin+, and the second terminal is electrically connected to the base of the charging transistor Q10. The first terminal of the pre-charging resistor R3 is electrically connected to the base of the charging transistor Q10, and the second terminal is electrically connected to the positive electrode of the pre-charging diode D4 and the negative electrode is electrically connected the point SWC of the pre-charge diode D4 (ie, a negative voltage end of the flying capacitor). The collector of the enable triode QX is electrically connected to the base of the triode Q10, the emitter is electrically connected to the input negative terminal Vin−, and the resistance of the pre-charging resistor R2 is equal to the resistance of the pre-charging resistor R3. Before the power conversion circuit 1/2/3 is started, the voltage across the flying capacitor C1 is zero, and at this time, the triode QX is controlled to be turned off, so that the base voltage of the charging triode Q10 is increased, the input voltage Vin charges the voltage across the flying capacitor C1 to Vin/2 through Q10, and when the voltage across the flying capacitor C1 is charged to a preset value, the enable triode QX is controlled to be turned on, so that the base voltage of the charging triode Q10 is reduced, the charging triode Q10 is turned off, and the pre-charging process ends. Before the power conversion circuit 1/2/3 is started, if the voltage across the output capacitor C1 is not zero, and there is a preset voltage V1 lower than the steady-state operating voltage, the input voltage Vin charges the voltage across the flying capacitor C1 to a voltage value close to Vin/2 through Q10, and in an ideal state, the voltage across the flying capacitor C1 will be charged to (Vin-V1)/2. Due to the existence of pre-charging diode D4, and the cathode of the pre-charging diode D4 is electrically connected to the point SMC instead of Vin, so that the flying capacitor can be charged to (Vin−V1)/2 instead of Vin/2−V1, so that the flying capacitor voltage can be charged closer to the target Vin/2, thereby reducing the impact current generated by turn-on of the power switch at the starting moment of the power conversion circuit 1/2/3.

In some other embodiments, the power conversion apparatus further includes a pre-charging unit 72, as shown in FIG. 10B. Compared with the pre-charging unit 71, one pre-charging resistor R1 is added, the resistance of R1 is equal to the resistance of R2 or the resistance of R3. One end of the pre-charging resistor R1 is electrically connected with the output positive terminal Vo+, the other end of the pre-charging resistor R1 is electrically connected with a pair of ground mirror current mirrors, and the other group of mirror current mirrors is electrically connected with the input positive terminal Vin+. By adding the pre-charging resistor R1, regardless of the magnitude of the bias voltage V1, the voltage across the flying capacitor C1 can be charged to Vin/2, and the impact current generated at the moment when the power switch circuit 1/2/3 is turned on is completely eliminated.

The power conversion apparatus disclosed in the present disclosure may be a part of an electronic setting, various components in the power conversion apparatus may be disposed on the same circuit board together with other components in the electronic device, a winding in the power conversion apparatus is disposed on the circuit board, and various components in the power conversion apparatus are electrically connected by using a circuit board. The power conversion device may also be a power module.

The switch in the foregoing embodiment is merely used as an example for an SI MOSFET, or may be a switch such as a SiC MOSFET, a Hunan MOSFET, or an IGBT MOSFET, and a connection manner of the switch may be correspondingly adjusted according to different switch types. The power supply module described in the above embodiments may also be an electronic device, as long as the layout on the electronic device meets the technical features and benefits disclosed in the present disclosure.

The “equal” or “same” or “equal to” disclosed in the present application shall consider the parameter distribution of the project, and the error distribution is within ±30%; the included angle between the two line segments or the two straight lines is less than or equal to 45 degrees; the included angle between the two line segments or the two straight lines “perpendicular” defines that the included angles between the two line segments or the two straight lines are within the range of [60, 120]; the definition of the phase “wrong phase” also needs to consider the parameter distribution of the engineering, and the error distribution of the phase error degree is within +30%.

What is claimed is:

1. A power conversion circuit, comprising an input end, an output end, an upper switch, a middle switch, at least two lower switches, a flying capacitor and a winding;
wherein the input end comprises an input positive terminal and an input negative terminal, the output end comprises an output positive terminal and an output negative terminal, and the input negative terminal is electrically connected with the output negative terminal;
wherein the upper switch, the middle switch and the lower switch form a three-switch bridge arm;
wherein one end of the upper switch is electrically connected to the input positive terminal, the other end of the upper switch and one end of the middle switch are electrically connected to a upper node of the three-switch bridge arm, the other end of the middle switch and one end of a lower switch of the three-switch bridge arm are electrically connected to a lower node of the three-switch bridge arm, and the other end of the lower switch of the three-switch bridge arm is electrically connected to the input negative terminal;
wherein a first end of the winding is electrically connected with one end of the flying capacitor, the other end of the flying capacitor is electrically connected to the upper node of the three-switch bridge arm, a second end of the winding is electrically connected to one end of the other lower switch, and the other end of the other lower switch is electrically connected to the input negative terminal.

2. The power conversion circuit of claim 1, wherein the winding is a high-voltage winding, the power conversion circuit further comprises two low-voltage windings, the second ends of the two low-voltage windings are electrically connected, the first end of one low-voltage winding is electrically connected with the lower node of the three-switch bridge arm, and the first end of the other low-voltage winding is electrically connected with the second end of the high-voltage winding.

3. The power conversion circuit of claim 2, wherein the second ends of the two low-voltage windings are respectively electrically connected to the output positive terminal.

4. The power conversion circuit of claim 2, further comprising an inductor, wherein a second end of the two low-voltage windings is electrically connected to a second end of the inductor, and a first end of the inductor is electrically connected to the output positive terminal.

5. The power conversion circuit of claim 3, wherein the high-voltage winding comprises a first high-voltage winding and a second high-voltage winding, a first end of the first high-voltage winding is electrically connected to one end of the flying capacitor, a second end of the first high-voltage winding is electrically connected to a first end of the second high-voltage winding, and a second end of the second high-voltage winding is electrically connected to a first end of the other low-voltage winding.

6. The power conversion circuit of claim 1, further comprising a control signal group, the control signal group comprising a first control signal, a second control signal, a third control signal and a fourth control signal, wherein the first control signal and the second control signal are 180 degrees out of phase, the third control signal is complementary to the first control signal, the fourth control signal is complementary to the second control signal, the first control signal is used for controlling the turn-on and off of the upper switch, the second control signal is used for controlling the turn-on and off of the middle switch, the fourth control signal is used for controlling the turn-on and off of the lower switch in the three-switch bridge arm, and the third control signal is used for controlling the turn-on and off of the other lower switch.

7. A power conversion device, comprising a winding substrate, at least one switch, a transformer and an inductor, wherein the winding substrate comprises a first surface and a second surface which are opposite to each other;
the first surface comprises a transformer area, a switch area and an inductor area, and/or the at least one second surface comprises a transformer area, a switch area and an inductor area;
the switch area is arranged between the transformer area and the inductor area;
at least one switch is arranged in the switch area, the transformer is arranged in the transformer area, and the inductor is arranged in the inductor area.

8. The power conversion device of claim 7, wherein the first surface comprises an output area, and/or the second surface comprises an output area;
wherein the power conversion device further comprises at least one output capacitor, the at least one output capacitor is arranged in the output area, and the inductor area is arranged between the switch area and the output area.

9. The power conversion device of claim 7, wherein the second surface further comprises a flying capacitor region, the power conversion device further comprises at least one flying capacitor, the at least one flying capacitor is arranged in the flying capacitor region, and the flying capacitor region is arranged adjacent to the transformer region and the switch region.

10. The power conversion device of claim 7 wherein the switch comprises four lower switches, each of the first surface and the second surface comprises a switch area, the two lower switches are arranged in the switch area on the first surface, and the other two lower switches are arranged in the switch area on the second surface; and the projection of any lower switch arranged in the switch area of the first surface on the first surface overlaps with the projection of one lower switch arranged in the switch area of the second surface on the first surface.

11. A power supply module, comprising a winding substrate, a heat dissipation substrate and at least one component;
wherein the winding substrate comprises a first surface;
the at least one component is arranged on the first surface, and the at least one component comprises a non-welding-spot top-surface;
wherein the first surface of the winding substrate comprises at least one non-welding-spot area;
wherein the heat dissipation substrate comprises a bottom surface and a top surface, one part of the bottom surface is fixed to the non-welding-spot area by using heat conduction glue, and the other part of the bottom surface is fixed to the non-welding-spot top-surface by using heat conduction glue.

12. The power supply module of claim 11, wherein a top surface of the heat dissipation substrate is a plane, and the top surface of the heat dissipation substrate is used for connecting and fixing a heat dissipation device.

13. The power supply module of claim 11, wherein the winding substrate further comprises a second surface, and the second surface is opposite to the first surface; the power supply module further comprises at least one pin, the at least one pin is arranged on the second surface, and the power supply module is fixed and electrically connected with one external circuit substrate through the pin.

14. A power conversion device, comprising an inductor and a winding substrate;
wherein the winding substrate comprises at least one through hole, an internal wiring layer, a first surface and a second surface;
wherein the inductor comprises an inductor magnetic core and an inductor winding, the inductor magnetic core comprises two inductor magnetic substrates, a first winding column and a second winding column, the first winding column and the second winding column are arranged between the two inductor magnetic substrates, and a channel between the first winding column and the second winding column is defined as an inductor winding channel;
wherein the inductor magnetic core further comprises a first inductor winding channel side and a second inductor winding channel side, and the inductor winding channels penetrate through the first inductor winding channel side and the second inductor winding channel side;
wherein the inductor winding comprises an inductor internal winding and an inductor surface layer winding, the inductor internal winding is arranged on the internal wiring layer, and the inductor surface layer winding is arranged on the first surface;
wherein the inductor internal winding further comprises at least one internal through hole region, an internal first end, an internal second end, a first branch and a second branch, wherein the internal first end is an inductor input end, and the at least one internal through hole region is arranged at the internal second end;
wherein the inductor internal winding penetrates through the inductor winding channel, the first branch is wound around the first winding column, the second branch is woundaround the second winding column, and the at least one internal through hole area and the inductor input end are arranged on the same side of the inductor magnetic core;
wherein the inductor surface layer winding comprises at least one surface layer through hole area, a surface layer first end and a surface layer second end, the at least one surface layer through hole area is arranged at the first end of the surface layer, the second end of the surface layer is an inductor output terminal, the inductor surface layer winding penetrates through the inductor winding channel, and the surface layer through hole area and the inductor output terminal are arranged on the two opposite sides of the inductor magnetic core;
wherein the surface through hole area is electrically connected with the internal through hole area through at least one through hole.

15. The power conversion device of claim 14, further comprising at least one component, wherein the at least one component is arranged on the first surface, and a projection of the at least one component on the inductor internal winding overlaps with at least a part of the first branch or the second branch.

16. The power conversion device of claim 14, wherein the inductor input end, the internal through hole region and the surface layer through hole region are arranged adjacent to the first inductor winding channel side, and the inductor output terminal is arranged adjacent to the second inductor winding channel side.

17. A power conversion device, comprising an input end, an output end, a flying capacitor, an output capacitor and a pre-charging circuit unit;
wherein the input end comprises an input positive terminal and an input negative terminal, the output end comprises an output positive terminal and an output negative terminal, and the input negative terminal and the output negative terminal are short-circuited;
wherein the flying capacitor is bridged between the input positive terminal and the output positive terminal;
wherein the output capacitor is bridged between the output positive terminal and the output negative terminal;
wherein one end of the pre-charging circuit unit is electrically connected with the input end of the power conversion device, and the other end of the pre-charging circuit unit is electrically connected with one end of the flying capacitor;
wherein a voltage between the input positive terminal and the input negative terminal is Vin, and the voltage at the two ends of the output capacitor is V1;
wherein before the power conversion device is started, Vin and V1 are configured to meet 0≤ V1<Vin 4, and the pre-charging circuit unit charges the flying capacitor to a preset value, the preset value being greater than (Vin/2−V1).

18. The power conversion device of claim 17, wherein when the voltage across the flying capacitor reaches a preset value by the pre-charging circuit unit, the pre-charging circuit unit stops working and the power conversion device starts to work.

19. The power conversion device of claim 18, wherein a maximum value of the preset value is Vin/2.

20. The power conversion device of claim 17, wherein the pre-charging circuit unit comprises a charging triode and a first charging diode, one end of the charging triode is electrically connected with the input positive terminal, the other end of the charging triode is electrically connected with a positive electrode of the first charging diode, and a negative electrode of the first charging diode is electrically connected with a positive voltage end of the flying capacitor.

21. The power conversion device of claim 20, wherein the pre-charging circuit unit further comprises a first pre-charging resistor and a second pre-charging resistor, the resistance values of the first pre-charging resistor and the second pre-charging resistor are equal, the first end of the first pre-charging resistor is electrically connected to the input positive terminal, and the second end of the first pre-charging resistor and the first end of the second pre-charging resistor are electrically connected to the base of the charging triode.

22. The power conversion device of claim 21, wherein a second end of the second pre-charging resistor is electrically connected to an input negative terminal.

23. The power conversion device of claim 21, further comprising a second charging diode, a second end of the second pre-charging resistor being electrically connected to a positive electrode of the second charging electrode, and a positive electrode of the second charging electrode being electrically connected to a negative voltage end of the flying capacitor.

24. The power conversion device of claim 23, further comprising an enabling triode, wherein a collector electrode of the enabling triode is electrically connected to a base electrode of the charging triode, and an emitter electrode of the enabling triode is electrically connected to an input negative terminal.

25. A power conversion device, comprising a three-switch bridge arm, a first voltage and a second voltage; the three-switch bridge arm comprises an upper switch, a middle switch and a lower switch; and the upper switch, the middle switch and the lower switch are sequentially and electrically connected in series;
wherein the first voltage is less than the second voltage;
wherein the first voltage is used for driving power supply of the lower switch, and the second voltage is used for driving power supply of the middle switch and the upper switch.

26. The power conversion device of claim 25, further comprising a first bootstrap diode and a second bootstrap diode, wherein a positive electrode of the first bootstrap diode is electrically connected to the first voltage, and a negative electrode of the first bootstrap diode is electrically connected to a driving circuit of the middle switch; and a positive electrode of the second bootstrap diode is electrically connected to a negative electrode of the second bootstrap diode, and a negative electrode thereof is electrically connected to a driving circuit of the upper switch.

27. A power conversion device, comprising a power conversion circuit, a starting power supply unit, an output power supply unit, a working power supply unit and a microprocessor, wherein the power conversion circuit comprises an input end and an output end, and the starting power supply unit is electrically connected with the input end;
wherein when the power conversion circuit is in a standby state or a starting state, the starting power supply unit supplies power to the output power supply unit, and the output power supply unit supplies power to the microprocessor;
wherein when the starting state of the power conversion circuit is finished, the starting power supply unit stops working, the working power supply unit supplies power to the output power supply unit, and the output power supply unit supplies power to the microprocessor.

28. The power conversion device of claim 27, wherein the microprocessor is used for outputting a control signal, and when the starting state of the power conversion circuit is finished, the control signal controls the starting power supply unit to stop working.

29. The power conversion device of claim 27, wherein the working power supply unit comprises a coupling winding, a power supply diode and at least one power supply capacitor; the power conversion circuit comprises a power conversion winding, the coupling winding is coupled with the power conversion winding, and coupling voltages at two ends of the coupling winding are rectified and filtered by the power supply diode and the power supply capacitor to supply power to the output power supply unit.

30. A power conversion device, comprising a winding substrate and a transformer;
wherein the winding substrate comprises at least one internal wiring layer, a first surface and a second surface;
wherein the transformer comprises a high-voltage winding and two low-voltage windings, wherein the high-voltage winding and the two low-voltage windings are arranged on the internal wiring layer;
wherein the number of layers of the internal wiring layer occupied by each of the low-voltage windings is greater than the number of layers of the internal wiring layer occupied by the high-voltage winding.

31. The power conversion device of claim 30, wherein the number of layers of the wiring layer occupied by each of the low-voltage windings is twice the number of layers of the wiring layer occupied by the high-voltage winding.

32. The power conversion device of claim 30, wherein the second ends of the two low-voltage windings are electrically connected to form a center tap connection point.

33. The power conversion device of claim 32, wherein the transformer further comprises a transformer magnetic core, and the transformer magnetic core comprises a first transformer magnetic substrate, a second transformer magnetic substrate, a first side column, a second side column and a middle column; the first side column, the first transformer magnetic substrate, the middle column, the second transformer magnetic substrate and the second side column are sequentially arranged in the same direction; a channel between the first side column and the middle column is a first transformer winding channel, and a channel between the second side column and the middle column is a second transformer winding channel; the transformer magnetic core further comprises a first transformer winding channel side and a second transformer winding channel side opposite to each other; and the first transformer winding channel and the second transformer winding channel penetrate through the first transformer winding channel side and the second transformer winding channel side.

34. The power conversion device of claim 33, wherein after the high-voltage winding sequentially passes through the first transformer winding channel and the second transformer winding channel, the high-voltage winding is wound around at least two circles around the middle column; and the first end and the second end of the high-voltage winding are located on the same winding channel side of the transformer.

35. The power conversion device of claim 33, wherein the high-voltage winding comprises a first high-voltage winding and a second high-voltage winding, the first high-voltage winding surrounds the first side column winding in the first direction from the first end of the first high-voltage winding to the second end of the first high-voltage winding, the first high-voltage winding penetrates through the first transformer winding channel from the second transformer winding channel side to the first transformer winding channel side, and the second end of the first high-voltage winding is electrically connected with the first end of the second high-voltage winding;
wherein the second high-voltage winding is wound from the first end of the second high-voltage winding to the second end of the second high-voltage winding, the second high-voltage winding is wound around the second side column in the second direction, and the second high-voltage winding passes through the second transformer winding channel from the second transformer winding channel side to the first transformer winding channel side.

36. The power conversion device of claim 33, wherein the first end and the second end of each low-voltage winding are arranged on the first transformer winding channel side or the second transformer winding channel side; each low-voltage winding is wound around the first side column or the second side column in the same direction from the first end of the corresponding low-voltage winding to the second end of the corresponding low-voltage winding, and the second ends of the two low-voltage windings are electrically connected.

37. The power conversion device of claim 33, wherein the first end and the second end of each low-voltage winding are arranged on the first transformer winding channel side or the second transformer winding channel side; and each low-voltage winding is wound around the middle column in different directions from the first end of the corresponding low-voltage winding to the second end of the corresponding low-voltage winding, and the second ends of the two low-voltage windings are electrically connected.

38. The power conversion device of claim 33, wherein the first end and the second end of each low-voltage winding are respectively arranged on the first transformer winding channel side and the second transformer winding channel side; each low-voltage winding passes through the first transformer winding channel side and the second transformer winding channel side from the first end of the corresponding low-voltage winding to the second end of the corresponding low-voltage winding, and the second ends of the two low-voltage windings are electrically connected.
